(19) United States
(12) Patent Application Publication
(10) Pub. No.: US 2009/0198595 A1
(43) Pub. Date: Aug. 6, 2009

(54) Hand-held web browser inventory checking system

(76) Inventors: Quentin Olson, Poulsbo, WA (US); Wayne Baratta, Poughkeepsie, NY (US)

Correspondence Address: SAILE ACKERMAN LLC, 28 DAVIS AVENUE, POUGHKEEPSIE, NY, 12603, US

(21) Appl. No.: 12/012,393

(22) Filed: Feb. 1, 2008

(51) Int. Cl. G06Q 10/00

(52) U.S. Cl. 705/28

(57) ABSTRACT

This invention provides a system and a method for real-time checking and inputting business inventory. The business operations range from a single branch to a large chain of stores or branches. The application utilizes a hand-held web-browser based system which allows store and business operators to view and input inventory to a back-office server in real-time to assist in the management and security of businesses. The programming for the system resides in an out-of-store back office server. The hand-held device is simply a web browser with a bar code scanner. This system and method facilitates easy inventory checking for real-time theft and loss prevention.

### RELATED PATENT APPLICATION

This application is related to docket number TY2006-001, filed on Feb. 26, 2007, Ser. No. 11/710,722, which is herein incorporated by reference in its entirety.

### BACKGROUND OF THE INVENTION

1. Field of the Invention

This invention relates to a system and a method for real-time checking and inputting business inventory. The business operations range from a single branch to a large chain of stores or branches.

More particularly this invention relates to a hand-held web-browser based system which allows store and business operators to view and input inventory to a back-office server in real-time to assist in the management and security of businesses.

2. Description of Related Art

Current practice in the field of inventory management includes running an inventory application for retail stores, restaurants, warehouses, loading docks, and manufacturing operations on hand-held devices, then storing and uploading data to a computer server in a back room of the business operation or to a remote server in non-real time operation. During the time between storing and uploading data to the server, the inventory application is presenting inaccurate or not current information, because of the time delay to update the information at the server. Typically, hand-held devices currently used in inventory control systems need unique programs and substantial dedicated storage to operate. Therefore, the setup and testing of these hand-held devices is time-consuming and laborious.

U.S. Pat. No. 6,851,611 B1 (Shaw-Sinclair) describes a personal inventory system which uses a hand-held device which can read barcodes. The system allows users to organize, access, edit, and update information about items that they own.

U.S. Pat. No. 7,092,947 B2 (Zellner et al.) describes a portable telecommunication test set, such as a telephone line butt set, with a web browser included. The test equipment allows the technician to access the Internet and other remotely stored information to retrieve data and other useful technical information while in the field for network or line maintenance, trouble-shooting or repair.

U.S. Pat. No. 6,662,193 B1 (Christensen) discloses systems and methods for gathering and updating inventory data within a database through the use of hand-held devices.

U.S. Pat. No. 5,399,844 (Holland) describes an inspection prompting and reading recording system which includes a portable computer having a display, a keyboard, a bar scanner, a memory, a processor and a sound generator.

### BRIEF SUMMARY OF THE INVENTION

It is the objective of this invention to provide a system and a method for real-time checking and inputting of business inventory.

It is further an object of this invention to provide a hand-held web-browser based system which allows store and business operators to view and input inventory to a back-office server in real-time to assist in the management and security of businesses.

The objects of this invention are achieved by a hand-held web browser inventory checking system comprising one or more hand-held terminals and one or more web servers. The hand-held terminals and web servers communicate via wireless Internet protocols. The hand-held terminals are implemented with personal digital assistants (PDAs). The web server is implemented with web server hardware and software, using one or more relational databases. The programming for the hand-held devices resides in and is executed from the web server.

### BRIEF DESCRIPTION OF THE DRAWINGS

FIG. 1 shows a block diagram of the elements of this invention.

FIG. 2 is a more detailed diagram of a main embodiment of this invention.

FIG. 3 is a flowchart which illustrates the type of inventory checking procedures that are done with this hand-held system.

### DETAILED DESCRIPTION OF THE INVENTION

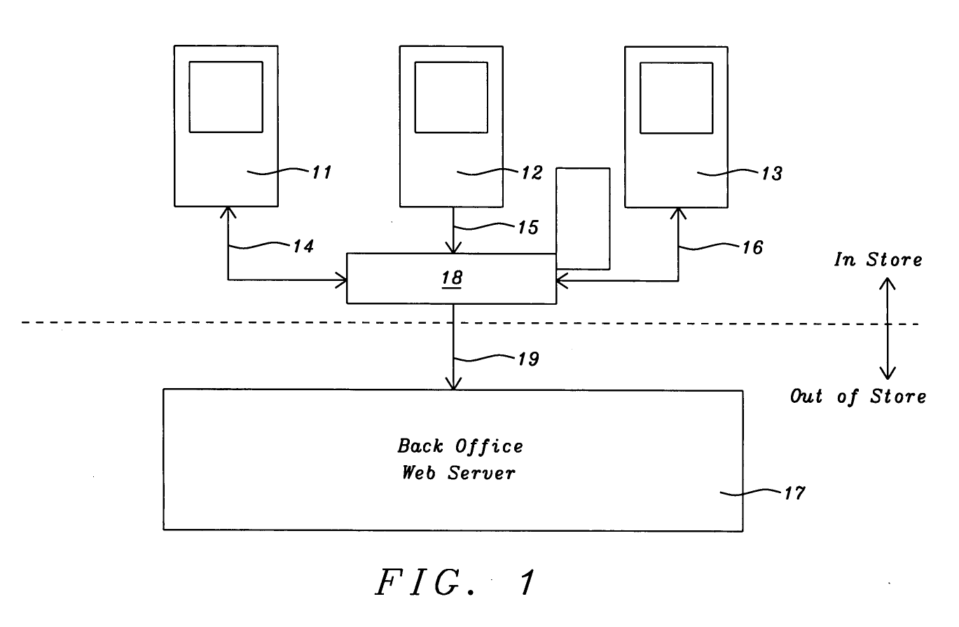

FIG. 1 shows a high level diagram of this invention. An out-of-store back office (BO) web server 15, as described in related patent application Ser. No. 11/710,722 filed on Feb. 26, 2007, is shown. This back office web server contains databases which include company inventory and sales transaction records. Hand-held (HH) units 11, 12, and 13 are also shown. These HH terminals have limited storage and minimal program processing, but are able to access the web via web browsing. These HH units have live wireless connections 14, 15, 16 to an in-store wireless router 18. This wireless router 18 communicates with the out-of-store back office server 17 via a high-speed broadband link 19 such as DSL (digital subscriber line) as shown in FIG. 1. In addition, the HH units have scanners such as bar code scanners or radio frequency identification (RFID) scanners for scanning, counting and inputting the store inventory to the BO web server.

Typically, the hand-held devices are personal digital assistants (PDAs). They contain microprocessors and about 64 megabytes of random access memory (RAM). These hand-held devices have the ability to perform as web browsers displaying web pages from the Internet. They communicate with wireless routers via wireless technologies such as the standard WiFi 802.11 b and g protocols. Typical hand-held devices are the Symbol PDA (Motorola, Holtsville, N.Y.), the Intermec CN2 PDA (Intermec Technologies, Everett, Wash.), and the Falcon PSC 4200 PDA (Datalogic (formerly PSC), Bologna, Italy).

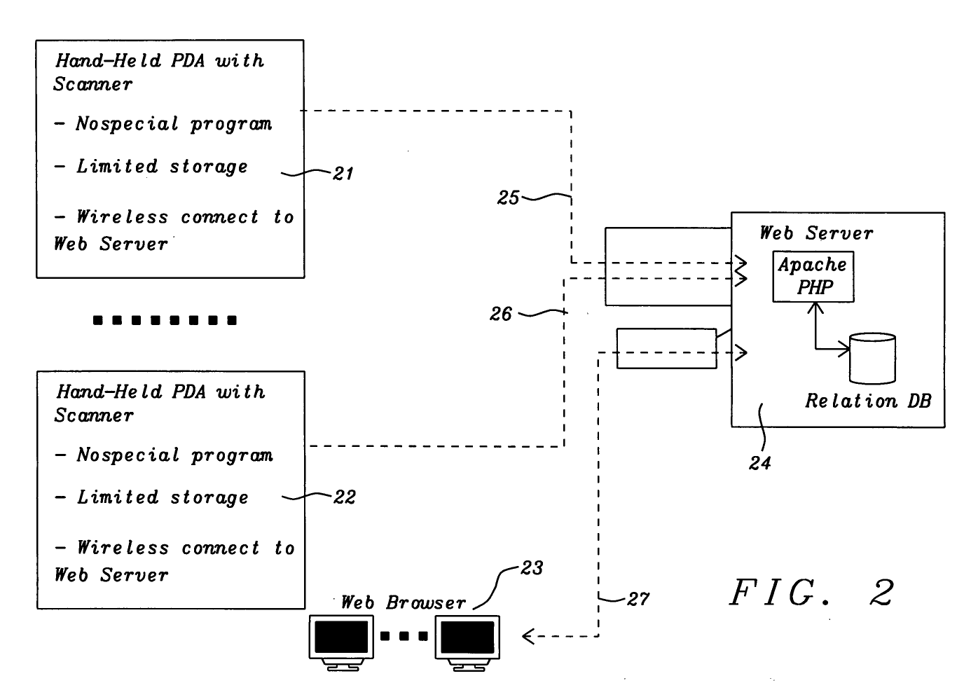

FIG. 2 shows a more detailed block diagram of the device and the store system where it is used. Two hand-held units or PDAs (personal data assistants) with bar code scanners are shown 21, 22. These are shown communicating with an out of store BO web server 24 via wireless connections 25, 26 respectively. FIG. 2 also shows both local and remote web browsers 23 accessing the BO web server, via a high-speed connection such as DSL 27, in order to view store and company status and to input store data. In addition, the HH devices 21, 22 are also web browsers. They also have the ability to view store and company status and to input store data such as inventory and inventory checking results. Since the HH devices 21,22 have no special program and limited storage, the HH programming is located in the BO server 24.

Web Server 24 illustrates a BO implemented with Apache PHP using relational databases. PHP (recursive acronym for “PHP: Hypertext Preprocessor”) is a widely-used Open Source general-purpose scripting language that is especially suited for Web development and can be embedded into HTML (hypertext markup language). Apache is a web server currently used in over half of all web sites worldwide. PHP code is different from a script written in other languages like Perl or C. Instead of writing a program with lots of commands to output HTML, one can write an HTML script with some embedded code to do something (i.e. to output some text). The PHP code is enclosed in special start and stop tags that allow a jump into and out of “PHP mode”. What distinguishes PHP from something like client-side JavaScript is that the code is executed on the server. If there is HTML script with PHP code imbedded in it, the client would receive the results of running that script, with no way of determining what the underlying code may be. A web server can even be configured to process all HTML files with PHP. The advantages of using PHP are that it is extremely simple for a newcomer, free to use, but offers many advanced features for a professional programmer. A programmer can jump in and in a short time start writing simple scripts. Remote and local web browsers 23 illustrate a method used by store managers, corporate administrators, or system administers to access and view a company & its store's instantaneous performance from minute to minute. The POS, BO, and Web Browsers all communicate via the Web 27. The protocols between the PDAs 21, 22, the web browsers 23 and BO server 24 are HTTPs, XMLURPC. 35. XML-RPC is a remote procedure call protocol which uses XML to encode its calls and HTTP as a transport mechanism. It is a very simple protocol which defines only a handful of data types and commands.

The system in FIG. 2 is used for 1) real time scanning for inputting inventory and 2) real time scanning for outputting inventory for checking and comparing counted inventory on the store shelves. This system is very useful as a check against theft and faulty store/company operations.

In FIG. 2, all inventory and transaction data is stored in relational databases in the BO server 24. A relational database stores all of its data inside tables. All operations on data are done on the tables themselves. Some operation produce other tables as the result. A table is a set of rows and columns. Each row is a set of columns with only one value for each. All rows from the same table have the same set of columns, although some columns may have NULL values. A NULL value is an “unknown” value. The rows from a relational table are analogous to a record, and the columns are analogous to a field. Below is an example of a relational table.

| NAME | COMPANY | E_MAIL |
|---|---|---|
| Jane A. Doe | ABC | jad@abc.com |
| Bill X. Smith | XYZ | bxs@xyz.com |

There are two basic operations one can perform on a relational table. The first one is retrieving a subset of its columns. The second is retrieving a subset of its rows. The field names such as company describe the content of the columns of the relational table. The rows delineate the individual records stored in the relational tables.

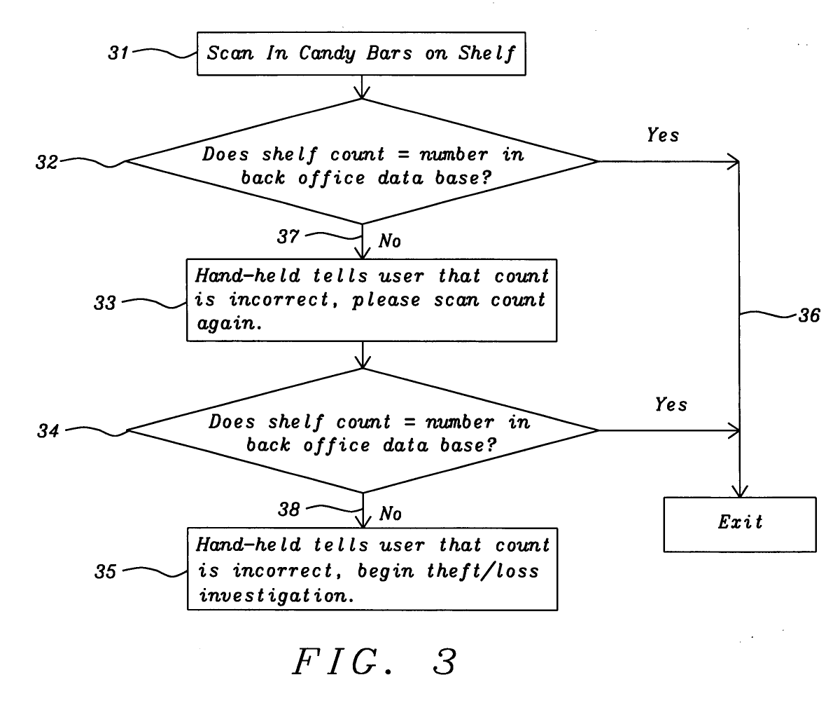

FIG. 3 shows an example flowchart that is implemented in programming in the BO web server 24 shown in FIG. 2. The purpose of the flowchart in FIG. 3 is to prompt the store worker using the HH device to check the store inventory and to report to the store worker if the in-store count is correct. The first step 31 is to use the hand-held PDA to scan in the candy bar packages on the shelf. Next, the candy bar shelf count is compared 32 to the number of candy bars in the back office database. If the back office database candy bar count does not equal the shelf count 37, the flowchart directs the worker to count again 33. If that count comparison fails again 38, the flowchart tells the store worker to begin theft/loss investigations 35. If the comparisons are equal 36, the program flow exits normally with acknowledgement of a successful count comparison. Typically, the flowchart of FIG. 3 would be implemented in the PHP web server programming language discussed above.

The key advantages of this hand-held web browser inventory checking system are as follows. The hand-held devices have live wireless web connections to a back office (BO) server outside of the store. Also, there is no special programming required in the hand-held device. All operations are reflected real-time into the BO server's inventory database. For example, all inventory scanned or inputted from the hand-held device appears instantly in the BO database, which is instantly viewable anywhere in the world via web browsers. The hand-held devices can check in store inventory against the expectations of the BO server in order to check real time against theft and loss. Another big advantage is that all hand-held computer programs are located and executed in the BO server. In fact, the hand-held device can do all back office operations. For example, from the hand-held device, products can be added, deleted, and their prices can be changed. Since these changes are immediately visible from any manager's PC at their home or at headquarters, there is always management oversight of these changes. This hand-held device allows for local in-store flexibility, but also provides for corporate control and standardization. It also eliminates the need for any server to be located in the store. Another advantage of this system is the use of standard PC and web architecture which offers both full-scalability without degrading system performance. This results in improved performance and lower cost of implementing these business systems. There is a lower cost associated with projects developed with the technology of this invention due to the flexibility of easy design changes and well-understood software. There is less training required for programmers and system testers. Projects can draw on the huge talent pool in the open source development community. The invention allows configurable software modules for different types of businesses and sales promotions. The invention allows remote monitoring of both the hand-held devices and back-office systems from anywhere via the web. There is minimal time required for hand-held device installation, since hand-held device setup is as basic as a home PC setup. Another advantage is that the hand-held inventory checking system can be provided as a service or deployed within a corporation. For example, Software as a Service (SMS) is a software distribution model in which applications are hosted by a vendor or service provider and made available to customers over a network, typically the Internet. Another advantage of this invention is that the hand-held system is maintained in customer centric databases, making it impossible for customers to see other's data. Each hand-held inventory system client gets their own instance of a database. When they log into the BO they are attached to their own relational database associated and validated via their user login and password.

While this invention has been particularly shown and described with Reference to the preferred embodiments thereof, it will be understood by those Skilled in the art that various changes in form and details may be made without Departing from the spirit and scope of this invention.

What is claimed is:

1. A hand-held web browser inventory checking system, comprising:
one or more hand-held terminals and
one or more web servers,
wherein said hand-held terminals and said web servers communicate via wireless Internet protocols,
wherein said hand-held terminals are implemented with personal digital assistants (PDAs),
wherein said web server is implemented with web server hardware and software, using one or more relational databases,
wherein programming for said hand-held devices resides in and is executed from said web server.

2. The hand-held web browser inventory checking system of claim 1 wherein said hand-held terminals and said web servers are implemented with executable, configurable software modules, wherein said modules can be easily changed to implement different functions for different businesses.

3. The hand-held web browser inventory checking system of claim 1, wherein said hand-held terminals can scan codes which identify individual inventory items.

4. The hand-held web browser inventory checking system of claim 1, wherein said hand-held system and said web servers are scalable allowing the addition of hand-held terminals and business locations without degrading system performance.

5. The hand-held web browser inventory checking system of claim 1, wherein a real-time status of said hand-held terminals and said web servers is obtained at remote locations via personal computers with browser based web access.

6. A hand-held web browser system comprising:
one or more web servers,
wherein said web servers are implemented with web server hardware and software, using one or more relational databases,
wherein said web servers can communicate with hand-held terminals via Internet protocols,
wherein programming for said hand-held devices resides in and is executed from said web servers.

7. The hand-held web browser of claim 6, wherein said web servers are implemented with executable, configurable software modules, wherein said modules can be easily changed to implement different functions for different businesses.

8. The hand-held web browser of claim 6, wherein said web servers issue commands to said hand-held terminals instructing store owner how to check inventory.

9. The hand-held web browser system of claim 6, wherein said web servers are scalable allowing the addition of hand-held terminals and business locations without degrading system performance.

10. The hand-held web browser system of claim 6, wherein a real-time status of said hand-held terminals and/or said back-office system is obtained at remote locations via personal computers with browser based web access.

11. A hand-held web browser system comprising,
one or more hand-held terminals,
wherein said hand-held terminals can communicate with web servers via Internet protocols,
wherein said hand-held terminals are implemented with personal computer hardware and software, using one or more relational databases,
wherein programming for said hand-held devices resides in and is executed from said web server.

12. The hand-held web browser system of claim 11, wherein said hand-held terminals are implemented with executable, configurable software modules, wherein said modules can be easily changed to implement different functions for different businesses.

13. The hand-held web browser system of claim 11, wherein said hand-held terminals can scan codes which identify individual inventory items.

14. The hand-held web browser system of claim 11, wherein said hand-held web browser system is scalable allowing the addition of said hand-held terminals and business locations without degrading system performance.

15. The hand-held web browser system of claim 11, wherein a real-time status of said hand-held terminals and/or said web servers is obtained at remote locations via personal computers with browser based web access.

16. A method of providing a hand-held web browser inventory checking system, comprising the steps of:
providing one or more hand-held terminals and
providing one or more web servers,
wherein said hand-held terminals and said web servers communicate via wireless Internet protocols,
wherein said hand-held terminals are implemented with personal digital assistants (PDAs),
wherein said web server is implemented with web server hardware and software, using one or more relational databases,
wherein programming for said hand-held devices resides in and is executed from said web server.

17. The method of providing a hand-held web browser inventory checking system of claim 16 wherein said hand-held terminals and said web servers are implemented with executable, configurable software modules, wherein said modules can be easily changed to implement different functions for different businesses.

18. The method of providing a hand-held web browser inventory checking system of claim 16, wherein said hand-held terminals can scan codes which identify individual inventory items.

19. The method of providing a hand-held web browser inventory checking system of claim 16, wherein said hand-held system and said web servers are scalable allowing the addition of hand-held terminals and business locations without degrading system performance.

20. The method of providing a hand-held web browser inventory checking system of claim 16, wherein a real-time status of said hand-held terminals and said web servers is obtained at remote locations via personal computers with browser based web access.

21. A method of providing a hand-held web browser system comprising the steps of:
providing one or more web servers,
wherein said web servers are implemented with web server hardware and software, using one or more relational databases,
wherein said web servers can communicate with hand-held terminals via Internet protocols,
wherein programming for said hand-held devices resides in and is executed from said web servers.

22. The method of providing a hand-held web browser of claim 21, wherein said web servers are implemented with executable, configurable software modules, wherein said modules can be easily changed to implement different functions for different businesses.

23. The method of providing a hand-held web browser of claim 21, wherein said web servers issue commands to said hand-held terminals instructing store owner how to check inventory.

24. The method of providing a hand-held web browser system of claim 21, wherein said web servers are scalable allowing the addition of hand-held terminals and business locations without degrading system performance.

25. The method of providing a hand-held web browser system of claim 21, wherein a real-time status of said hand-held terminals and/or said web servers is obtained at remote locations via personal computers with browser based web access.

26. A method of providing a hand-held web browser system comprising the steps of:
providing one or more hand-held terminals,
wherein said hand-held terminals can communicate with web servers via Internet protocols,
wherein said hand-held terminals are implemented with personal computer hardware and software, using one or more relational databases,
wherein programming for said hand-held devices resides in and is executed from said web server.

27. The method of providing a hand-held web browser system of claim 26, wherein said hand-held terminals are implemented with executable, configurable software modules, wherein said modules can be easily changed to implement different functions for different businesses.

28. The method of providing a hand-held web browser system of claim 26, wherein said hand-held terminals can scan codes which identify individual inventory items.

29. The method of providing a hand-held web browser system of claim 26, wherein said hand-held web browser system is scalable allowing the addition of said hand-held terminals and business locations without degrading system performance.

30. The method of providing a hand-held web browser system of claim 26, wherein a real-time status of said hand-held terminals and/or said web servers is obtained at remote locations via personal computers with browser based web access.
